(19) United States
(12) Patent Application Publication
(10) Pub. No.: US 2025/0094301 A1
(43) Pub. Date: Mar. 20, 2025

(54) MEMORY APPARATUS, TEST FIXTURE, AND TEST SYSTEM

(71) Applicant: Yangtze Memory Technologies Co., Ltd., Hubei (CN)

(72) Inventor: Jie ZHU, Wuhan (CN)

(21) Appl. No.: 18/441,746

(22) Filed: Feb. 14, 2024

(30) Foreign Application Priority Data
Sep. 18, 2023 (CN) 202311208347.0

(51) Int. Cl. G06F 11/273

(52) U.S. Cl. CPC G06F 11/2733

(57) ABSTRACT

Examples of the present disclosure provide a memory apparatus, a test fixture, and a test system. The memory apparatus includes a main circuit board and a memory controller. The main circuit board includes a test interface configured to receive first startup data. The memory controller is disposed on the main circuit board and connected to the test interface, and second startup data is stored in the memory controller. The memory controller is configured to acquire the second startup data, in response to determining that acquiring the second startup data fails, acquire the first startup data through the test interface, and perform an initialization operation on the memory apparatus according to the first startup data.

### CROSS-REFERENCE TO RELATED APPLICATIONS

This application claims priority to Chinese Patent Application No. 202311208347.0, filed on Sep. 18, 2023, which is hereby incorporated by reference in its entirety.

### TECHNICAL FIELD

The present disclosure relates to the technical field of semiconductors, and particularly to a memory apparatus, a test fixture, and a test system.

### BACKGROUND

A Solid State Drive (SSD) gradually becomes the mainstream of the market due to its advantages such as fast read and write speeds, an ultra-strong anti-shock capability, and extremely low power consumption, etc. Also, with the development of cloud computation and big data technologies, the solid state drive still has a very broad market prospect.

Before outgoing from a factory, the solid state drive should undergo activation, as well as a series of tests and debugging, etc., so as to ensure that the outgoing solid state drive has good storage performance, reliability, and stability. The solid state drive has highly refined hardware and complex firmware, and therefore inevitably fails to start up normally in some cases, thereby affecting subsequent tests or debugging of the solid state drive.

### SUMMARY

In view of the above, examples of the present disclosure provide a memory apparatus, a test fixture, and a test system.

According to a first aspect of the present disclosure, a memory apparatus is provided, which comprises:
a main circuit board comprising a test interface configured to receive first startup data; and
a memory controller disposed on the main circuit board and connected to the test interface, wherein the memory controller stores second startup data, and wherein
the memory controller is configured to: acquire the second startup data; in response to determining that acquring the second startup data fails, acquire the first startup data through the test interface; and perform an initialization operation on the memory apparatus according to the first startup data.

In some examples, the memory controller is configured to:
in response to determining that acquiring the second startup data fails, enable, based on a select signal, an external storage device that provides the first startup data, generate a startup data request signal, and receive the first startup data provided by the external storage device in response to the startup data request signal; and
the test interface is further configured to output the select signal and the startup data request signal.

In some examples, the memory controller is configured to:
output a clock signal through the test interface and sample the first startup data based on the clock signal; and
provide a supply voltage and a ground voltage to the external storage device through the test interface.

In some examples, the test interface comprises a plurality of test pads;
the memory controller is connected with the plurality of test pads, so as to output the select signal, the startup data request signal, the clock signal, the supply voltage, and the ground voltage and receive the first startup data, through the plurality of test pads.

In some examples, the test interface comprises:
a first test pad connected to a supply pin of the memory controller and configured to output the supply voltage;
a second test pad connected to a ground pin of the memory controller and configured to output the ground voltage;
a third test pad connected to a chip select signal pin of the memory controller and configured to output the select signal;
a fourth test pad connected to a clock pin of the memory controller and configured to output the clock signal;
a fifth test pad connected to a signal output pin of the memory controller and configured to output the startup data request signal; and
a sixth test pad connected to a signal input pin of the memory controller and configured to receive the first startup data.

In some examples, the first startup data comprises a read-only memory code and a bootloader;
the memory controller is configured to: run a read-only memory program according to the read-only memory code, verify the bootloader using the read-only memory program, and run a bootloader according to the verified bootloader, so as to complete the initialization operation.

In some examples, the memory controller is further configured to:
after being powered on, acquire the second startup data; and
when succeeding in acquiring the second startup data, perform the initialization operation on the memory apparatus according to the second startup data.

In some examples, the main circuit board comprises a first side and a second side disposed oppositely, and the memory controller is disposed on the first side of the main circuit board;
the test interface is disposed on the first side or the second side of the main circuit board.

In some examples, the memory apparatus further comprises: an input/output connector disposed at an end of the main circuit board, wherein the test interface is located between the memory controller and the input/output connector;
the memory apparatus further comprises:
a non-volatile memory disposed on the first side of the main circuit board and located on a side of the memory controller away from the input/output connector.

In some examples, the memory controller is configured to: in response to determining that acquiring the second startup data fails, output a startup data load failure signal through the input/output connector.

According to a second aspect of the present disclosure, a test fixture is provided, which comprises:
a test substrate;
a startup data storage device disposed on the test substrate, wherein first startup data is stored in the startup data storage device; and
a test connector disposed on the test substrate and connected with the startup data storage device, wherein the test connector is configured for contact connection with a test interface on a memory apparatus.

In some examples, the startup data storage device comprises: a read-only memory, wherein the first startup data is stored in the read-only memory.

In some examples, the test connector comprises: a plurality of ejector pins each being configured for contact connection with one test pad in the test interface.

In some examples, the test fixture further comprises:
a signal conversion module disposed on the test substrate;
a first conversion interface connected with the signal conversion module; and
a second conversion interface connected with the signal conversion module and configured to connect with an input/output connector of the memory apparatus, wherein the first conversion interface is different from the second conversion interface.

In some examples, a switch is disposed between the test connector and the startup data storage device;
after the memory apparatus outputs a startup data load failure signal, the switch is closed to enable the startup data storage device.

According to a third aspect of the present disclosure, a test system is provided, which comprises a test fixture and a memory apparatus;
the test fixture comprising: a startup data storage device and a test connector disposed on a test substrate, wherein first startup data is stored in the startup data storage device, and the test connector is connected with the startup data storage device;
the memory apparatus comprising: a main circuit board and a memory controller, wherein the main circuit board comprises a test interface, the memory controller is disposed on the main circuit board and connected with the test interface, the memory apparatus is installed on the test fixture, and the test interface and the test connector are in contact connection.

In some examples, second startup data is stored in the memory controller;
the memory controller is configured to: acquire the second startup data; in response to determining that aquring the second startup data fails, acquire first startup data in the startup data storage device; and perform an initialization operation on the memory apparatus according to the first startup data.

In some examples, the memory controller is configured to:
in response to determining that aquring the second startup data fails, enable the startup data storage device based on a select signal, send a startup data request signal to the startup data storage device, and receive the first startup data provided by the startup data storage device in response to the startup data request signal.

In some examples, the test interface comprises a plurality of test pads, and the memory controller is connected with the plurality of test pads;
the test connector comprises a plurality of ejector pins, the startup data storage device is connected with the plurality of ejector pins, and each of the ejector pins is in contact connection with one of the test pads.

In some examples, the test interface comprises:
a first test pad connected to a supply pin of the memory controller and configured to supply a supply voltage to the startup data storage device;
a second test pad connected to a ground pin of the memory controller and configured to supply a ground voltage to the startup data storage device;
a third test pad connected to a chip select signal pin of the memory controller and configured to output the select signal to the startup data storage device;
a fourth test pad connected to a clock pin of the memory controller and configured to provide a clock signal to the startup data storage device;
a fifth test pad connected to a signal output pin of the memory controller and configured to output the startup data request signal to the startup data storage device; and
a sixth test pad connected to a signal input pin of the memory controller and configured to receive the first startup data from the startup data storage device.

In the memory apparatus provided by the examples of the present disclosure, the test interface is disposed on the main circuit board to receive the first startup data provided by the external storage device, so that when the memory controller fails to acquire the second startup data stored therein, the memory controller may continue to complete the initialization operation using the first startup data. Such configuration first can prevent the occurrence of a case where the second startup data is corrupted so that the memory apparatus fails to complete the initialization. Secondly, a position and a wiring of the test interface are more flexible, and an area occupied by the test interface on the main circuit board may be smaller. These characteristics are favorable to a size reduction of the main circuit board and thus favorable to device miniaturization, and may also reduce layout difficulty and simplify a main board design.

Furthermore, the first startup data in the external storage device may be burned in advance, and different memory apparatuses may share the external storage device, so as to acquire the first startup data by connecting the external storage device through the test interface, thereby shortening a test period. Particularly when a case where a plurality of memory apparatuses fail to be initialized occurs during a test process, these memory apparatuses may share the same external storage device, thereby greatly simplifying a debugging process and improving product debugging efficiency while reducing costs.

### BRIEF DESCRIPTION OF THE DRAWINGS

FIG. 1A is a schematic diagram of an example system provided by examples of the present disclosure;

FIG. 1B is an architecture diagram of a memory card provided by examples of the present disclosure;

FIG. 1C is an architecture diagram of an SSD provided by examples of the present disclosure;

FIG. 2 is a schematic structural diagram of a memory apparatus provided by examples of the present disclosure;

FIG. 3 is a schematic structural diagram of another memory apparatus provided by examples of the present disclosure;

FIG. 4 is another partial schematic structural diagram of the memory apparatus shown in FIG. 3;

FIG. 5 is a schematic diagram of connection between a memory controller and a test interface provided by examples of the present disclosure;

FIG. 6 is a schematic structural diagram of a test fixture provided by examples of the present disclosure;

FIG. 7 is a schematic diagram of connection between a startup data storage device and a test connector provided by examples of the present disclosure; and

FIG. 8 is a schematic diagram of a test system provided by examples of the present disclosure.

### DETAILED DESCRIPTION

The technical solutions of the present disclosure will be further described below in detail in conjunction with the drawings and examples.

It should be understood that, spatially relative terms, such as “beneath”, “below”, “lower”, “under”, “over”, “upper”, and the like, may be used herein for ease of description to describe the relationship between one element or feature and other elements or features as illustrated in the figures. It should be understood that, the spatially relative terms are intended to further encompass different orientations of a device in use or operation in addition to the orientation depicted in the figures. For example, if a device in the drawings is turned over, then an element or a feature described as “below other elements”, or “under other elements”, or “beneath other elements” will be orientated to be “above” the other elements or features. Thus, the example terms, “below” and “beneath”, may comprise both upper and lower orientations. The device may be orientated otherwise (rotated by 90 degrees or other orientations), and the spatial descriptors used herein are interpreted accordingly.

The terms used herein are only intended to describe the examples, and are not used as limitations of the present disclosure. The terms “comprised of” and/or “comprise”, when used in this specification, determine the presence of a feature, integer, step, operation, element and/or component, but do not preclude the presence or addition of one or more of other features, integers, steps, operations, elements, components, and/or groups. As used herein, the term “and/or” comprises any and all combinations of the listed relevant items.

It should be noted that the technical solutions set forth in the examples of the present disclosure may be combined freely in the case of no conflicts.

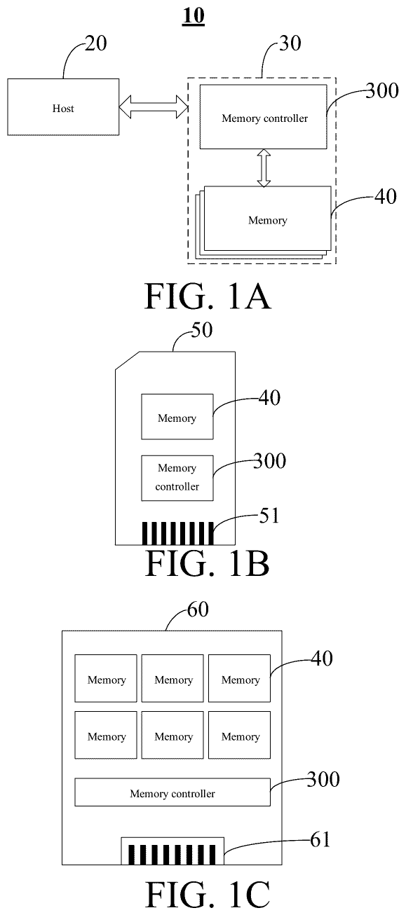

As shown in FIG. 1A, examples of the present disclosure provide an example system 10. The example system 10 may comprise a host 20 and a memory apparatus 30. The example system 10 may include, but is not limited to, a mobile phone, a desktop computer, a laptop computer, a tablet computer, a vehicle computer, a gaming console, a printer, a positioning apparatus, a wearable electronic apparatus, a smart sensor, a Virtual Reality (VR) apparatus, an Augmented Reality (AR) apparatus, or any other suitable electronic apparatus having memories 40 therein. The host 20 may be a processor (e.g., a Central Processing Unit (CPU) or a System on Chip (SoC) (e.g., an Application Processor (AP)) of an electronic apparatus.

In an example of the present disclosure, the host 20 may be configured to send or receive data to or from the memory apparatus 30. Here, the memory apparatus 30 may comprise a memory controller 300 and one or more memories 40. The memories 40 may include, but are not limited to, a NAND Flash Memory, a 3D NAND Flash Memory, a NOR Flash Memory, a Dynamic Random Access Memory (DRAM), a Ferroelectric Random Access Memory (FRAM), a Magnetoresistive Random Access Memory (MRAM), a Phase Change Random Access Memory (PCRAM), a Resistive Random Access Memory (RRAM), and a Nano Random Access Memory (NRAM), etc.

In an example of the present disclosure, the memory controller 300 may be coupled to the memories 40 and the host 20, and is configured to control the memories 40. In an example, the memory controller 300 may be designed for operating in low duty-cycle environments such as a Secure Digital (SD) card, a Compact Flash (CF) card, a Universal Serial Bus (USB) flash drive, or other media for use in electronic apparatuses, such as a personal computer, a digital camera, and a mobile phone, etc. In some examples, the memory controller 300 may be also designed for operating in a high duty-cycle environment such as an SSD or an embedded Multi-Media Card (eMMC), which may be used as a data memory for mobile apparatuses, such as a smartphone, a tablet computer, and a laptop computer, etc., and an enterprise memory array.

In an example of the present disclosure, the memory controller 300 and the one or more memories 40 may be integrated into various types of memory apparatuses, for example, be included in the same package (such as a Universal Flash Storage (UFS) package or an eMMC package). That is to say, a memory system 30 may be implemented and packaged into different types of end electronic products. As shown in FIG. 1B, the memory controller 300 and a single memory 40 may be integrated together to form a memory card 50. The memory card 50 may include a Personal Computer Memory Card International Association (PC) card, a CF card, a Smart Media (SM) card, a memory stick, a Multi-Media Card (MMC, Reduced-Size MMC (RS-MMC), and MMCmicro), an SD card (SD, miniSD, microSD, Secure Digital High Capacity (SDHC)), and a UFS, etc. The memory card 50 may further comprise a memory card connector 51 coupling the memory card 50 with a host (e.g., the host 20 in FIG. 1A). In another example as shown in FIG. 1C, the memory controller 300 and a plurality of memories 40 may be integrated together to form an SSD 60. The SSD 60 may further comprise an SSD connector 61 coupling the SSD 60 with a host (e.g., the host 20 in FIG. 1A). In some implementations, a storage capacity and/or an operation speed of the SSD 60 are greater than a storage capacity and/or an operation speed of the memory card 50.

The memory controller 300 can manage data in the memories 40 and communicate with the host. The memory controller 300 may be configured to control read, erase and program operations, etc., of the memories 40, may be further configured to manage various functions with respect to data stored or to be stored in the memories 40, including, but not limited to, bad-block management, garbage collection, logical-to-physical address conversion, and wear leveling, etc., and may be further configured to process Error Checking and Correction (ECC) with respect to data read from or written to the memories 40. Furthermore, the memory controller 300 may be further configured to communicate with an external apparatus (e.g., the host 20 in FIG. 1A) according to a particular communication protocol. In an example, a host interface controller may communicate with an external host through at least one of various interface protocols, such as a USB protocol, an MMC protocol, a Peripheral Component Interconnect (PCI) protocol, a Peripheral Component Interconnect Express (PCI-E) protocol, an Advanced Technology Attachment (ATA) protocol, a serial ATA protocol, a parallel ATA protocol, a Small Computer System Interface (SCSI) protocol, an Enhanced Small Drive Interface (ESDI) protocol, an Integrated Development Equipment (IDE) protocol, and a Firewire protocol, etc. It is to be understood that the memory controller 300 may further perform any other suitable functions, such as formatting the memories 40 and initializing the memory apparatus 30, etc.

In an example, startup of the memory apparatus 30, also referred to as initialization of the memory apparatus 30, mainly comprises two stages. A first stage is the memory controller 300 executing a Read Only Memory code (ROM code), and a second stage is loading and executing a bootloader.

In an example, the memory controller 300 may comprise a processor, a Read-Only Memory (ROM), and a Tightly-Coupled Memory (TCM). In an example, the tightly-coupled memory may be implemented using a Random Access Memory (RAM) as an example.

The ROM code is stored inside the memory controller 300, and particularly, the ROM code is solidified in the read-only memory. After the memory controller 300 is powered on, the ROM code is executed first. Generally speaking, after the memory controller 300 is powered on, the processor reads the ROM code from a fixed address stored in the read-only memory, so as to run a read-only memory program (ROM program).

In some examples, the bootloader may be stored in the read-only memory.

When the processor runs the ROM program, the ROM program searches for a bootloader file in the read-only memory and loads the bootloader file into the tightly-coupled memory. The processor runs the ROM program to verify the bootloader file in the tightly-coupled memory. After verification is passed, the processor jumps and runs a bootloader according to the bootloader, so as to complete an initialization operation of the memory apparatus.

The memory controller 300 completes initialization of the entire system by executing the ROM code and the bootloader. During an initialization process, the memory controller 300 performs relevant settings of the memory apparatus, so that after the initialization is completed, the host or an activation apparatus can recognize the memory apparatus. At this time, the activation apparatus may burn a firmware program required by running of the memory apparatus (e.g., the SSD) to the memory apparatus.

In view of important roles of the ROM code and the bootloader in the system initialization, in order to prevent a case where the ROM code and the bootloader inside the memory controller is corrupted so that the memory apparatus fails to be initialized, in some examples, installation positions for an external storage device and related components may be reserved on a main circuit board of the memory apparatus.

If a case where an error of the ROM code and/or the bootloader within the memory controller 300 causes a failure in running the bootloader occurs during debugging, the external storage device and the related components may be mounted manually, the ROM code and/or the bootloader file may be burned to the external storage device, and the memory controller 300 may call the ROM code and/or the bootloader file from the external storage device to complete the system initialization, so that the debugging can be performed on the memory apparatus.

Such a method can remedy the problem of the internal error of the memory controller that causes the memory apparatus to fail to start up. However, manually mounting the external storage device and the related components is cumbersome and laborious, and the ROM code and/or the bootloader file will be written to the external storage device after the mounting, thereby increasing a test period and cost. Particularly in a case where a plurality of memory apparatuses fail to start up, these operations are required to be repeated multiple times, thereby greatly increasing a production period and cost. Furthermore, the installation positions reserved for the external storage device and the related components occupy a large area of the main board, which is unfavorable to device miniaturization.

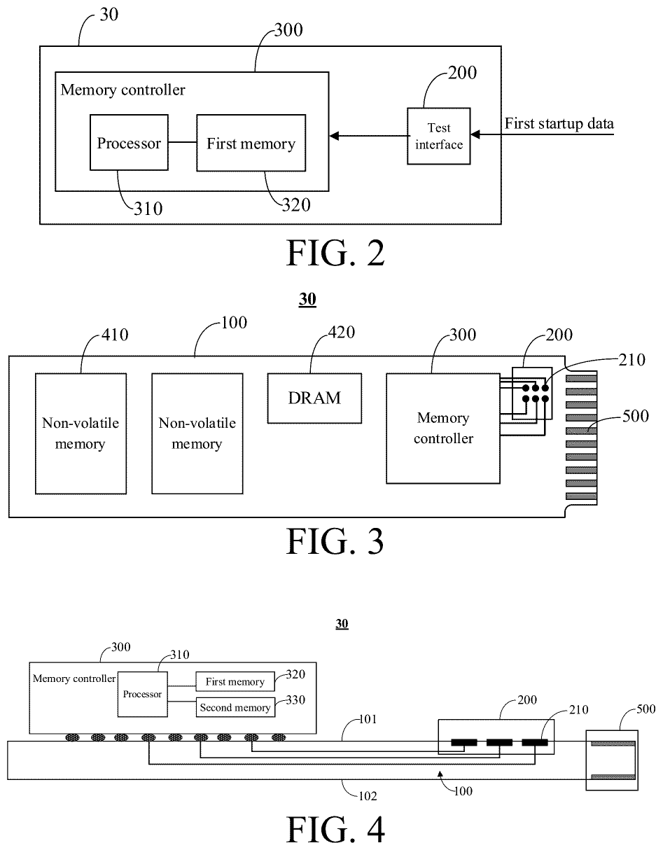

Another example of the present disclosure provides a memory apparatus, which may solve the problem of an internal fault of the memory controller that causes the memory apparatus to fail to start up, and may also reduce a debugging period and cost. FIG. 2 is a schematic structural diagram of a memory apparatus provided by the examples of the present disclosure. As shown in FIG. 2, the memory apparatus 30 comprises:
a main circuit board comprising a test interface 200 configured to receive first startup data; and
a memory controller 300 disposed on the main circuit board and connected to the test interface 200, wherein second startup data is stored in the memory controller 300;
the memory controller 300 is configured to: acquire the second startup data, in response to determining that aquring the second startup data fails, acquire first startup data through the test interface 200, and perform an initialization operation on the memory apparatus according to the first startup data.

FIGS. 3 and 4 are schematic structural diagrams of another memory apparatus provided by the examples of the present disclosure. The memory apparatus provided by the examples of the present disclosure is described in detail below in conjunction with FIGS. 3 and 4.

In the examples of the present disclosure, a main circuit board 100 may be a Printed Circuit Board (PCB). The main circuit board 100 is a support for electronic components and is also a carrier for achieving electrical connection of the electronic components with each other. The main circuit board 100 comprises a first side 101 and a second side 102 that are opposite. The components may be centrally disposed on one side of the main circuit board 100, such as the first side 101. Alternatively, the components may be also disposed on both sides of the main circuit board 100, that is, the components are disposed on both the first side 101 and the second side 102 of the main circuit board 100.

Device pads (not shown in the figures) are disposed on a surface of the main circuit board 100, and the electronic components are soldered on the device pads of the main circuit board. Metal wiring and vias are arranged on the surface of and/or inside the main circuit board, and the metal wiring is connected with the device pads corresponding to different components, so that the electronic components are electrically connected with each other.

With continued reference to FIGS. 3 and 4, in this example, the memory apparatus 30 comprises a memory controller 300 and one or more memory devices, where the memory controller 300 and the memory devices are integrated on the same main circuit board 100. The memory devices may include a non-volatile memory 410, which may include a NAND memory or other non-volatile memories (such as a PCRAM and a FRAM) as included in the above memories 40. In an example, the memory controller 300 and the non-volatile memory 410 are both disposed on the first side 101 of the main circuit board 100.

A plurality of first device pads corresponding to the memory controller 300, as well as a plurality of second device pads corresponding to the memory devices, are disposed on the first side 101 of the main circuit board 100. A plurality of pins of the memory controller 300 are soldered with the plurality of first device pads in one-to-one correspondence, while a plurality of pins of the memory devices are soldered with the plurality of second device pads in one-to-one correspondence. The first device pads and the second device pads are connected through the metal wiring and the vias, thereby achieving electrical connection of the memory controller 300 and the memory devices.

It is to be understood that, in another example, the memory controller 300 and some of the memory devices may be disposed on the first side 101 of the main circuit board 100, while the other memory devices are disposed on the second side 102 of the main circuit board 100.

The memory apparatus further comprises an input/output connector 500 configured to install the memory apparatus on a host and responsible for signal transmission between the host and the memory apparatus. During a test process of the memory apparatus, the input/output connector 500 is connected to a test apparatus, and the test apparatus sends a signal to the memory apparatus through the input/output connector 500, so as to perform a test or debugging on the memory apparatus.

In some examples, as shown in FIG. 3, the input/output connector 500 is disposed at an end of the main circuit board 100 so as to be installed to the host. The memory controller 300 is disposed adjacent to the input/output connector 500, and the non-volatile memory 410 is disposed at an end of the memory controller 300 away from the input/output connector 500.

In some examples, the input/output connector 500 in an SSD is typically a golden finger. The golden finger is configured to be inserted into a corresponding slot on the host, so as to install the SSD to the host and achieve electrical connection. An example structure of the golden finger is determined by an interface protocol of the memory controller 300 and the host.

In addition, the memory apparatus may further comprise a DRAM 420, which is connected to the memory controller 300 and is a data transfer station between the host and the memory controller 300. Data sent by the host to the memory apparatus 30 may be cached in the DRAM 420 first, and then written by the memory controller 300 to the non-volatile memory 410. That is, disposing the DRAM 420 can improve data transmission efficiency between the host and the memory apparatus 30.

With continued reference to FIG. 3, in this example, the main circuit board 100 further comprises a test interface 200 connected to the memory controller 300. The test interface 200 receives first startup data sent by an external storage device and transmits the first startup data to the memory controller 300.

That is, in this example, the test interface 200 is used to replace the device pads on the main circuit board 100 reserved for an external storage device and related components, and the external storage device and the related components are disposed on a structure outside the storage device. For example, “the external storage device and the related components” may be disposed on a test fixture as a startup data storage device. During a test process, when the memory apparatus has a problem of failing in initialization, the test interface 200 is connected to an external startup data storage device to provide the first startup data for the memory controller 300, so that the memory apparatus completes system initialization.

The structure of the test interface 200 is not limited by the present disclosure. In this example, as shown in FIGS. 3 and 4, the test interface 200 may comprise one or more test pads 210 (also referred to as test points). The test pads 210 and the device pads may be formed at the same time and have similar structures. For example, the test pads may be flat metal pads.

A shape of the test pads 210 is not limited by the present disclosure. In an example, the test pads 210 may be circular, elliptical, square, polygonal (e.g., hexagonal), and teardrop-shaped, etc.

Compared with the device pads whose size, spacing, and arrangement should be consistent with those of pins of the components, a size, a spacing, and an arrangement of the test pads 210 are more flexible. The arrangement of the plurality of test pads may be adjusted according to a size of the main circuit board 100 or a layout of other components, and the size and the spacing of the test pads may be also adjusted (e.g., reduced). Moreover, the test pads may be covered with solder resist ink (typically referred to as green ink) when not involved in tests related thereto, so as to reduce a probability of oxidation. When they are to be used, the green ink covering the test pads is removed.

It is to be understood that, in some other examples, the test interface 200 may be also a connector commonly used for tests in the art.

In some examples, as shown in FIG. 4, the test interface 200 and the memory controller 300 may be disposed on the same side of the main circuit board 100. That is, the test interface 200 is also disposed on the first side 101 of the main circuit board. In other examples, the test interface 200 and the memory controller 300 may be also disposed on both sides of the main circuit board respectively, that is, the test interface 200 is disposed on the second side 102 of the main circuit board.

It is to be understood that, if the test interface 200 is a test pad, the test interface 200 may be disposed on either side of the main circuit board without affecting a thickness of the memory apparatus. If the test interface 200 is a connector, then the test interface 200 and the other components (such as the memory controller 300) may be disposed on the same side, so as to avoid an increase in the thickness of the memory apparatus.

In addition, the electrical connection of the test interface 200 and the memory controller 300 is not limited in the present disclosure. Taking the test interface 200 comprising a plurality of test pads 210 as an example, the plurality of test pads and the plurality of first device pads corresponding to the memory controller 300 may be electrically connected in one-to-one correspondence, that is, one test pad is electrically connected to one first device pad. The test pads and the first device pads may be not electrically connected in one-to-one correspondence either. The connection of the plurality of first device pads and the plurality of test pads 210 depends on a signal interaction between the memory controller 300 and the external startup data storage device. During practical use, a connection relationship of the first device pads and the test pads 210 is set according to a signal between the memory controller 300 and the external startup data storage device.

In some examples, the first device pads and the test pads 210 are connected through the metal wiring or through the metal wiring and the vias. In an example, the memory controller 300 and the test pads 210 are disposed on the first side 101 of the main circuit board 100, and the first device pads and the test pads 210 may be connected through the metal wiring arranged on the first side 101 of the main circuit board 100. In some other examples, the first device pads and test pads 210 may be connected to inner layer wires or second side 102 wires of the main circuit board 100 through the vias, and interconnected in the inner layer wires or the second side 102 wires using the metal wiring, so as to electrically connect the memory controller 300 and the test pads 210.

With continued reference to FIG. 3, in this example, the memory controller 300 comprises a processor 310 and a first memory 320. The processor 310 and the first memory 320 are integrated inside a memory controller 300 chip, and may be considered as a processor module and a memory module inside the memory controller 300.

The first memory 320 is a memory that does not lose data after power-off, i.e., a non-volatile memory. In this example, the first memory 320 may be a Read-Only Memory (ROM), which may include a Mask ROM (MROM), a Programmable ROM (PROM), an Erasable Programmable ROM (EPROM), and an Electrically Erasable Programmable ROM (EEPROM), etc. Second startup data is stored in the first memory 320. The second startup data may comprise a read-only memory code (ROM code) and a bootloader.

As described above, after the memory controller 300 is powered on, the processor 310 first acquires the ROM code from the internal first memory 320 (e.g., the read-only memory) to run a ROM program. The ROM program searches for a bootloader file in the first memory 320, so as to run a bootloader to complete the initialization. That is, the memory controller 300 may complete the apparatus initialization only when having loaded and executed the ROM code and the bootloader.

If the processor 310 fails to acquire the second startup data, then the first startup data stored in the external startup data storage device is acquired through the test interface 200, and an initialization operation is performed on the memory apparatus according to the first startup data.

In some examples, a cause for the processor 310 failing to acquire the second startup data may be: corruption of the internal ROM program or corruption of the bootloader, which ultimately causes a failure in completing the initialization operation. A cause for the corruption of the ROM program or the bootloader may be an ROM code error or a bootloader error, or may be physical damage to the first memory 320, which causes a failure in calling the ROM code and/or the bootloader file.

In some examples, the first startup data and the second startup data may be the same. That is, the first startup data may also comprise the read-only memory code (ROM code) and the bootloader. Regardless of the cause for the processor 310 failing to acquire the second startup data, the processor 310 may acquire the ROM code and/or the bootloader from the external startup data storage device as needed, so as to complete the initialization.

In an example, if the corruption of the ROM program inside the memory controller 300 causes the failure in completing the initialization, the processor 310 acquires the ROM code from the startup data storage device and then runs the ROM program, and the ROM program acquires the bootloader from the first memory 320. Alternatively, the processor 310 may also acquire the ROM code and the bootloader from the startup data storage device to complete the initialization. Such configuration makes writing of the code simpler and the initialization efficiency higher, and may avoid a case where an access to the external startup data storage device again is expected when the bootloader inside the memory controller 300 also has an error.

In a further example, if the corruption of the bootloader inside the memory controller 300 causes the failure in completing the initialization, then the ROM program may acquire the bootloader from the startup data storage device to complete the initialization.

In a further example, regardless of the cause for the processor 310 failing to acquire the second startup data, the processor 310 acquires the ROM code and/or the bootloader from the external startup data storage device, so as to complete the initialization.

In some other examples, the first startup data may be also different from the second startup data. It is to be understood that, in some examples, after the processor 310 fails to acquire the second startup data, a startup data load failure signal is output through the input/output connector 500. The startup data load failure signal may be presented in a form of a code on a display screen of an upper machine. Therefore, the cause for the processor failing to acquire the second startup data may be learned by analyzing the startup data load failure signal, so as to burn the ROM code or the bootloader in the external startup data storage device accordingly. For example, the first startup data may only comprise the bootloader, which is used when the ROM program can be run normally but the bootloader file cannot be retrieved from the first memory 320, or used when the retrieved bootloader file is corrupted and the bootloader cannot run.

In some examples, the second startup data may only comprise the read-only memory code (ROM code), while the bootloader may be stored in the non-volatile memory 410. Correspondingly, the first startup data may comprise the ROM code. Alternatively, the first startup data may also comprise the ROM code and the bootloader, that is, after the processor acquires the ROM code from the external startup data storage device to run the ROM program, the ROM program may acquire the bootloader file from the non-volatile memory 410 or the startup data storage device, so as to complete the initialization.

To sum up, during the test process, when an internal fault of the memory controller 300 causes the failure in completing the initialization, the external startup data storage device is enabled. The startup data storage device is connected with the test interface to provide the first startup data to the memory controller 300, so as to assist the memory controller 300 in completing the initialization.

In the memory apparatus provided by the examples of the present disclosure, the test interface 200 is used to replace positions on the main circuit board 100 that are reserved for the external storage device and the related components. Compared with the device pads of the external storage device and the related components, a position and a wiring of the test interface 200 are more flexible, and an area occupied by the test interface 200 on the main circuit board may be smaller. These characteristics are favorable to a size reduction of the main circuit board 100 and thus favorable to device miniaturization, and may also reduce layout difficulty and thus shorten a design period.

Furthermore, the external storage device and the related components are disposed outside the memory apparatus and are electrically connected to the memory controller 300 through the test interface 200, so that there is no need to mount the external storage device and the related components on the memory apparatus, thereby shortening a test period. Particularly when a plurality of memory apparatuses fail to be initialized during the test process, these memory apparatuses may be connected to the same startup data storage device so as to acquire the first startup data, without mounting on and writing of the first startup data to each memory apparatus. That is, after writing the first startup data to the external storage device at once, it may be applicable to the plurality of memory apparatuses, without processes of repeated mounting on and writing of the first startup data to the faulty memory apparatuses, thereby greatly simplifying a debugging process and improving product debugging efficiency.

In some examples, the processor 310 of the memory controller 300 is configured to:
when failing to acquire the second startup data, enable, based on a select signal, the external storage device that provides the first startup data, generate a startup data request signal, and receive the first startup data provided by the external storage device in response to the startup data request signal.

The test interface 200 is further configured to output the select signal and the startup data request signal.

The selection signal is also referred as a chip select enable signal. The memory controller 300 comprises a plurality of chip select pins, from which a plurality of chip select enable signal lines may be led out and connected to a plurality of chips respectively. The chip select enable signal is typically controlled by a master apparatus (the memory controller 300 here). For example, the chip select enable signal is effective at a low level. When the memory controller 300 accesses a certain chip, a level of a chip select pin connected with the chip is pulled down, so as to select the chip.

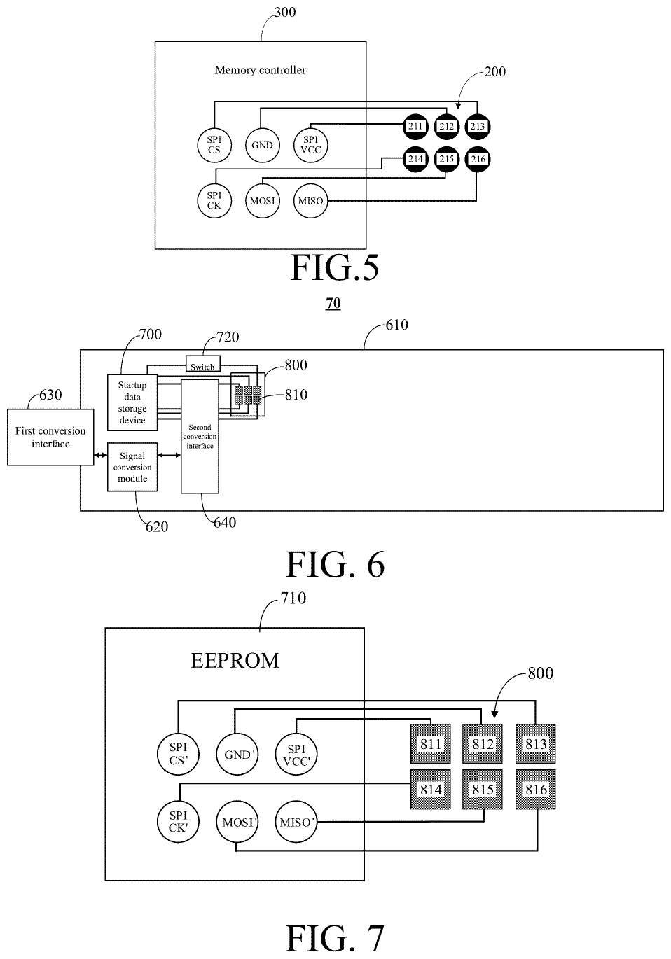

In this example, as shown in FIG. 5, one chip select pin Serial Peripheral Interface Chip Select (SPI CS) of the memory controller 300 is connected with the test interface 200. When the processor 310 fails to acquire the second startup data, the memory controller 300 switches a level of the chip select pin SPI CS from high to low, i.e., switching the select signal from a high level to a low level, so as to select the external startup data storage device, i.e., enabling the startup data storage device.

The memory controller 300 further comprises a Master Output Slave Input (MOSI) pin connected to the test interface. The MOSI pin (also referred to as a signal output pin herein) is used by the master apparatus to send a signal or data to a slave apparatus. In this example, the memory controller 300 sends the startup data request signal to the startup data storage device through the MOSI pin and test interface 200, so as request acquisition of the first startup data.

The memory controller 300 further comprises a Master Input Slave Output (MISO) pin connected to the test interface. The MISO pin (also referred to as a signal input pin herein) is used by the master apparatus to receive data sent by the slave apparatus. After receiving the startup data request signal sent by the memory controller 300, the external startup data storage device provides the first startup data in response to the startup data request signal. The first startup data is sent to the memory controller 300 via the test interface 200 and the MISO pin.

In some examples, the memory controller 300 is further configured to:
output a clock signal through the test interface 200 and sample the first startup data based on the clock signal; and
provide a supply voltage and a ground voltage to the external storage device through the test interface 200.

The clock signal is generated by the memory controller 300 and used for synchronizing a data transmission timing. Correspondingly, the memory controller further comprises: a clock pin SPI CLK connected to the test interface. The memory controller sends the clock signal to the external startup data storage device via the clock pin and the test interface 200, so as to control the data transmission timing.

When communication between the memory controller 300 and the external startup data storage device starts, the memory controller 300 pulls down the select signal connected to the test interface 200, so as to enable the startup data storage device. Then, the memory controller 300 sends the clock signal to the startup data storage device through the clock pin SPI CLK, and sends the startup data request signal through the MOSI pin. After receiving the startup data request signal, the startup data storage device sends the first startup data to the memory controller 300 through the MISO pin according to the clock signal sent by the memory controller 300. After the communication ends, the memory controller 300 pulls up the select signal from the low level, so as to release the external startup data storage device.

In some examples, the external startup data storage device is powered by the memory controller 300 during the communication with the memory controller 300. Correspondingly, the memory controller 300 further comprises a supply pin SPI VCC and a ground pin GND both connected to the test interface 200. During the communication between the memory controller 300 and the startup data storage device, the memory controller 300 provides power to the startup data storage device via the supply pin SPI VCC and the test interface 200, and provides a reference ground to the startup data storage device via the ground pin GND and the test interface 200, so as to enable the startup data storage device to work.

It is to be understood that, in some other examples, the power and the reference ground may be also provided by other devices to the startup data storage device. For example, the test apparatus, e.g., the upper machine, may provide the power and the reference ground to the startup data storage device. Alternatively, the startup data storage device may be equipped with a power supply module for separate power supply.

As described above, the test interface 200 may comprise the plurality of test pads 210. The plurality of pins of the memory controller 300 may be connected with the plurality of test pads 210 in one-to-one correspondence, so as to output the select signal, the startup data request signal, the clock signal, the supply voltage, and the ground voltage and receive the first startup data, through the plurality of test pads 210.

In some examples, FIG. 5 corresponds to the signal interaction between the memory controller 300 and the external startup data storage device, the test interface 200 may comprise:
a first test pad 211 connected to the supply pin SPI VCC of the memory controller and configured to output the supply voltage;
a second test pad 212 connected to the ground pin GND of the memory controller and configured to output the ground voltage;
a third test pad 213 connected to the chip select signal pin SPI CS of the memory controller and configured to output the select signal;
a fourth test pad 214 connected to the clock pin SPI CLK of the memory controller and configured to output the clock signal;
a fifth test pad 215 connected to the MOSI pin of the memory controller and configured to output the startup data request signal; and
a sixth test pad 216 connected to the MISO pin of the memory controller and configured to receive the first startup data.

Here, the first test pad 211, the second test pad 212, the third test pad 213, the fourth test pad 214, the fifth test pad 215, and the sixth test pad 216 all belong to the test pads 210. An arrangement of the above six test pads is not limited by the present disclosure. For example, as shown in FIG. 2, the six test pads may be arranged in a 2×3 array. Alternatively, the six test pads may be also arranged in a 3×2 array. Further alternatively, the six test pads may be arranged in a row or a column. The six test pads may be arranged in any form according to layout and wiring requirements.

In some examples, with continued reference to FIG. 4, the memory controller 300 further comprises: a second memory 330 connected to the test interface 200 and the processor 310 and configured to receive and store at least part of the first startup data.

For example, the second memory 330 may be a Random Access Memory (RAM), and the second memory 330 may be defined as a Tightly-Coupled Memory (TCM). In some examples, the processor 310 directly acquires the ROM code from the external startup data storage device to run the ROM program, and the second memory 330 may at least be configured to receive and store the bootloader. In some examples, the second memory 330 may be configured to receive and store the ROM code and the bootloader, and the processor 310 acquires the first startup data from the second memory 330 to complete the initialization.

In some examples, the memory controller 300 is configured to: when the memory controller 300 fails to acquire the second startup data, automatically acquire the first startup data from the external storage device. That is, after failing to acquire the second startup data, the memory controller 300 preferentially acquires the first startup data from the external startup data storage device by default.

A process in which initialization is completed by a memory controller 300 is described in detail below with an example. In an example, after the processor 310 detects that the memory controller 300 is powered on, the processor 310 reads the ROM code from a fixed address stored in the first memory 320 (a read-only memory), so as to run the ROM program. Then, the ROM program searches for the bootloader file in the first memory 320 and loads the bootloader file into the second memory 330 (a tightly-coupled memory). The processor 310 runs the ROM program to verify the bootloader file in the second memory 330. After verification is passed, the processor 310 jumps and executes the bootloader file, i.e., running the bootloader, so as to complete the initialization operation.

If an error of the ROM program and/or the bootloader causes the failure in completing the initialization, the memory controller 300 sends a startup data failure signal to the test apparatus through the input/output connector, and pulls down, by default, the chip select pin SPI CS connected to the test interface 200, so as to select the external startup data storage device. Afterwards, the memory controller 300 sends the clock signal to the startup data storage device through the clock pin SPI CLK, at the same time sends the startup data request signal through the MOSI pin, and provides power to the startup data storage device through the supply pin SPI VCC and the ground pin GND. After receiving the startup data request signal, the external startup data storage device sends the first startup data to the memory controller 300 through the MISO pin according to the clock signal sent by the memory controller 300. The first startup data may be stored in the second memory 330 of the memory controller 300.

After the communication ends, the memory controller 300 pulls up the select signal from the low level, so as to release the external startup data storage device. The memory controller 300 performs the initialization according to the first startup data in the second memory 330.

The examples of the present disclosure further provide a test fixture configured to perform a test or debugging on the memory apparatus 30. FIG. 6 is a schematic structural diagram of a test fixture provided by the examples of the present disclosure. As shown in FIG. 6, the test fixture 70 comprises: a test substrate 610; and a first conversion interface 630, a second conversion interface 640, and a signal conversion module 620 that are disposed on the test substrate 610. The signal conversion module 620 is connected with the first conversion interface 630 and the second conversion interface 640 respectively. The first conversion interface 630 is configured to connect the upper machine, and the second conversion interface 640 is configured to connect the input/output connector 500 of the memory apparatus. The first conversion interface 630 is different from the second conversion interface 640, and the signal conversion module 620 is configured to convert a signal of the first conversion interface 630 and a signal of the second conversion interface 640.

The input/output connector 500 in the above-mentioned memory apparatus typically conforms to a PCIe protocol or a SATA protocol, and may be presented in a form of the golden finger. The upper machine is typically a computer that uses a USB interface for communication. That is, the input/output connector 500 in the memory apparatus and the USB interface of the upper machine have different interface types and cannot be directly connected by plug-in. Therefore, the conversion interface and the signal conversion module 620 are desired to achieve connection and signal transmission between the memory apparatus and the upper machine.

In some examples, the first conversion interface 630 may be a USB plug, which is configured to be inserted into the USB interface of the upper machine.

According to the interface protocol to which the memory apparatus conforms, the second conversion interface 640 may be a PCIe interface or a SATA interface, and an example structure of the PCIe interface or the SATA interface may be a slot. The golden finger of the memory apparatus may be inserted into the slot of the test fixture.

In some examples, the signal conversion module 620 converts the signal of the first conversion interface 630 and the signal of the second conversion interface 640 according to the PCIe protocol (or the SATA protocol) and a USB protocol. In addition, a power conversion module may be also disposed on the test substrate 610 and connects the first conversion interface 630 and the signal conversion module 620, so as to increase the supply voltage that satisfies requirements of the memory apparatus. For example, the power conversion module is configured to convert a 5 V voltage received by the first conversion interface 630 (a USB plug) into a 3.3 V voltage.

In the examples of the present disclosure, the test substrate 610 may be a printed circuit board. Metal wiring and vias, configured to connect the first conversion interface 630, the second conversion interface 640, and the signal conversion module 620, are arranged in the test substrate 610.

With continued reference to FIG. 6, in this example, the startup data storage device 700 and a test connector 800 are further disposed on the test fixture 70. In an example, the test fixture further comprises:
the startup data storage device 700 disposed on the test substrate 610, wherein the first startup data is stored in the startup data storage device 700; and
the test connector 800 disposed on the test substrate 610 and connected with the startup data storage device 700, wherein the test connector 800 is configured for contact connection with the test interface 200 on the above-mentioned memory apparatus.

The startup data storage device 700 comprises a non-volatile memory. The non-volatile memory may be a Read-Only Memory (ROM), which may include a Programmable Read-Only Memory (PROM), an Erasable Programmable Read-Only Memory (EPROM), and an Electrically Erasable Programmable Read-Only Memory (EEPROM), etc. The non-volatile memory may also include a NAND memory, a Phase Change Random Access Memory (PCRAM), and a Ferroelectric Random Access Memory (FRAM), etc. In this example, the startup data storage device 700 includes the EEPROM. In addition, the startup data storage device 700 may further comprise some related components that enable the EEPROM to work normally.

The first startup data is stored in the startup data storage device 700. As described above, the first startup data may comprise the read-only memory code (ROM code) and the bootloader. It is to be understood that, during practical use, the first startup data may be burned to the startup data storage device 700 according to the fault of the memory apparatus or according to the requirements.

The test connector 800 is disposed on the test substrate 610 and connected with the startup data storage device 700. The test connector 800 is disposed as corresponding to the test interface 200 on the memory apparatus, and is configured for physical contact with the test interface 200.

In some examples, when the test interface 200 comprises a plurality of test pads 210, the test connector 800 may comprise a plurality of ejector pins 810. A number of the ejector pins is equal to a number of the test pads. An arrangement of the plurality of ejector pins and a spacing between adjacent ejector pins are identical to the arrangement of the plurality of test pads and the spacing between adjacent test pads, so that each ejector pin can be in contact connection with one test pad.

In one of the above examples of the present disclosure, the test interface 200 comprises six test pads 210 (211 to 216), and correspondingly, the test connector 800 may comprise six ejector pins 810 each being connected with one of the test pads 210. For example, as shown in FIG. 7, the test connector 800 comprises:
a first ejector pin 811 connected with a supply pin SPI VCC′ of the EEPROM 710 and configured for contact connection with the first test pad 211, wherein the supply pin SPI VCC′ of the EEPROM is configured to receive the supply voltage provided by the memory controller;
a second ejector pin 812 connected with a ground pin GND′ of the EEPROM and configured for contact connection with the second test pad 212, wherein the ground pin GND′ of the EEPROM is configured to receive the ground voltage provided by the memory controller;
a third ejector pin 813 connected with a chip select signal pin SPI CS′ of the EEPROM and configured for contact connection with the third test pad 213, wherein the chip select signal pin SPI CS′ of the EEPROM is configured to receive the select signal from the memory controller;
a fourth ejector pin 814 connected with a clock pin SPI CK′ of the EEPROM and configured for contact connection with the fourth test pad 214, wherein the clock pin SPI CK′ of the EEPROM is configured to receive the clock signal provided by the memory controller;
a fifth ejector pin 815 connected with a signal input pin MISO′ of the EEPROM and configured for contact connection with the fifth test pad 215, wherein the signal input pin MISO′ of the EEPROM is configured to receive the startup data request signal provided by the memory controller; and
a sixth ejector pin 816 connected with a signal output pin MOSI′ of the EEPROM and configured for contact connection with the sixth test pad 216, wherein the signal output pin MOSI′ of the EEPROM is configured to output the first startup data to the memory controller.

Here, the first ejector pin 811, the second ejector pin 812, the third ejector pin 813, the fourth ejector pin 814, the fifth ejector pin 815, and the sixth ejector pin 816 all belong to the ejector pins 810. For example, the ejector pins 810 may be spring ejector pins so that the ejector pin may abut against the test pads, thereby improving the connection reliability of the ejector pins and the test pads.

In an example, the ejector pins 810 are soldered on the test substrate 610. For example, the ejector pins 810 may be mounted on the test substrate 610 using a Surface Mounted Technology (SMT) or soldered on the test substrate 610 using a wave soldering process.

It is to be understood that, when the test interface 200 on the memory apparatus is a connection member, the test connector 800 on the test fixture should be a connector that matches the connection member.

During the test process (e.g., an activation process), when the input/output connector 500 of the memory apparatus is inserted into the second conversion interface 640 on the test fixture, the test connector 800 on the test fixture is in physical contact with the test interface 200 of the memory apparatus, causing a wire between the memory controller 300 and the startup data storage device 700 to be turned on. After a test starts, the upper machine supplies power to the memory controller 300, and the memory controller 300 starts to acquire the internal second startup data for initialization. If the memory controller 300 fails to acquire the second startup data, the memory controller 300 supplies power to the startup data storage device 700 based on a link of the test interface 200 and the test connector 800, sends the select signal, the startup data request signal, and the clock signal to the startup data storage device 700 to acquire the first startup data therefrom, and performs the initialization based on the first startup data. After the initialization of the memory apparatus is completed, the test apparatus (e.g., an activation apparatus) burns firmware to the memory apparatus through the upper machine, so as to complete activation of the memory apparatus.

In some examples, when the memory controller 300 fails to acquire the second startup data, the memory controller preferentially acquires the first startup data from the startup data storage device 700 by default. That is, the memory controller may select the startup data storage device 700 automatically and acquire the first startup data, without waiting for an instruction.

In some examples, when the memory controller 300 fails to acquire the second startup data, the memory controller 300 further sends the startup data load failure signal to the upper machine through the input/output connector 500. The startup data load failure signal may present in the form of the code a process of the memory controller failing to acquire the second startup data. A tester may determine the cause for the memory controller 300 failing to initialize the apparatus according to the startup data load failure signal displayed by a display of the upper machine.

In an example, while sending a second startup data load failure signal to the upper machine, the memory controller 300 may automatically acquire the first startup data from the startup data storage device 700 for initialization. An advantage of such configuration is that the initialization process of the memory apparatus is not interrupted, thereby improving testing efficiency.

In some other examples, the memory controller 300 is not allowed to automatically acquire the first startup data from the startup data storage device 700. In an example, after the memory controller 300 sends the startup data load failure signal to the upper machine, the memory controller 300 should be controlled by the upper machine or manually to acquire the first startup data from the startup data storage device. Such configuration can provide the first startup data accordingly after clear determination of the cause for the fault of the memory controller 300.

In some examples, the upper machine may send an instruction to the memory controller 300 through software, instructing the memory controller 300 to acquire the first startup data from the startup data storage device.

In some other examples, a switch 720 is disposed between the test connector 800 and the storage device. When the upper machine receives the startup data load failure signal output by the memory apparatus, the switch 720 is closed to enable the startup data storage device 700. Afterwards, the memory controller may acquire the first startup data from the startup data storage device 700. For example, the switch 720 may be closed manually, or the closing of the switch 720 may be controlled by the upper machine. In an example, the switch 720 may be disposed between any pin of the startup data storage device 700 and one of the ejector pins 810. For example, the switch 720 may be disposed between the supply pin SPI VCC′ of the EEPROM and the first ejector pin, or the switch 720 may be disposed between the signal input pin MISO′ of the EEPROM and the fifth ejector pin.

In some examples, if the memory controller 300 fails to acquire the second startup data, after the memory apparatus 30 completes the initialization according to the first startup data, that is, after the memory apparatus 30 starts up, the ROM code and/or the bootloader may be re-burned to the first memory 320 according to fault information of the second startup data displayed by the startup data load failure signal, so as to ensure that, when the memory apparatus is expected to be reinitialized subsequently (including after outgoing from a factory), the initialization may be performed according to the second startup data in the memory controller 300. In an example, the first memory 320 may include a PROM, an EPROM, and an EEPROM.

In the examples of the present disclosure, the startup data storage device and the test connector are disposed on the test fixture. After writing the first startup data to the startup data storage device for once, it may be applicable to a plurality of memory apparatuses, which can greatly improve the test efficiency. Furthermore, test interfaces may be reserved at the same position for memory apparatuses of different models, so that the test fixture is applicable to more memory apparatuses. That is, the test interfaces of different products may be disposed at the same coordinate position, so that a plurality of projects can share one set of test fixture, thereby reducing a test cost.

It is to be understood that, in some examples, the startup data storage device and the test connector may be added to an original test fixture (e.g., an activation fixture), so as to complete the initialization and activation of the memory apparatus using one test fixture. In an example, the test fixture provided by the present disclosure is an activation fixture, the activation apparatus comprises the upper machine and the activation fixture, and the activation fixture is connected with the upper machine and the memory apparatus. In this example, after the memory apparatus is powered on, the memory apparatus is initialized first. After the initialization is completed, a firmware (FW) program required for running of a solid-state hard disk is burned to the memory apparatus using the upper machine, thereby completing the activation of the memory apparatus.

In some other examples, a test fixture may be also provided additionally to install the startup data storage device and the test connector, so that when the memory controller fails to perform the initialization due to a failure in acquiring the second startup data, this test fixture is used to perform the initialization.

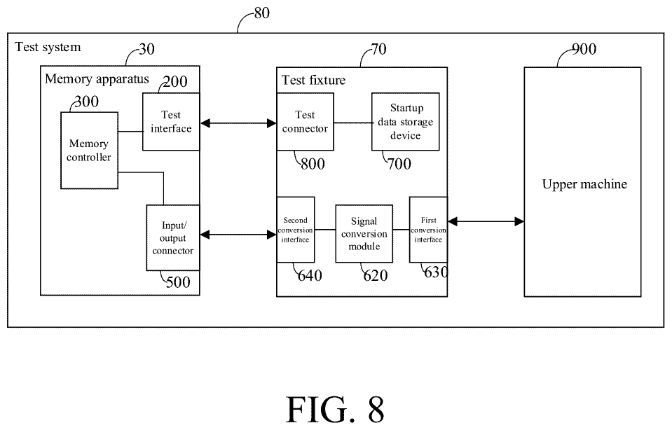

Examples of the present disclosure further provide a test system. FIG. 8 is a schematic diagram of a test system provided by the examples of the present disclosure. As shown in FIG. 8, the test system 80 comprises the test fixture 70 and the memory apparatus 30;
the test fixture 70 comprises: the startup data storage device 700 and the test connector 800 disposed on the test substrate 610, wherein the first startup data is stored in the startup data storage device 700, and the test connector 800 is connected with the startup data storage device 700;
the memory apparatus 30 comprises: the main circuit board and the memory controller 300, wherein the main circuit board comprises the test interface 200, and the memory controller 300 is disposed on the main circuit board and connected with the test interface 200. The memory apparatus 30 is installed on the test fixture 70, and the test interface 200 and the test connector 800 are in contact connection.

Further, the test system 90 also comprises the upper machine 900, and the upper machine 900 and the test fixture 70 belong to the test apparatus. In this example, the test apparatus may be the activation apparatus, the upper machine 900 may be further configured to burn the firmware to the memory apparatus 30, and the test fixture 70 is the activation fixture.

With continued reference to FIG. 8, the test fixture 70 further comprises the first conversion interface 630 and the second conversion interface 640, which are both connected to the signal conversion module 620. The first conversion interface 630 is connected with the upper machine 900 and may perform communication using the USB protocol. The second conversion interface 640 is connected with the input/output connector 500 on the memory apparatus 30 and may perform communication using the PCIe protocol or the SATA protocol. In an example, a firmware program code output by the upper machine 900 is sent to the memory apparatus 30 via the first conversion interface 630, the signal conversion module 620, and the second conversion interface 640.

Further, the memory controller 300 comprises: the first memory and the processor connected with the first memory, wherein the second startup data is stored in the first memory. The processor is configured to: acquire the second startup data in the first memory; when failing to acquire the second startup data, acquire the first startup data in the startup data storage device 700 via the test interface 200 and the test connector 800; and perform the initialization operation on the memory apparatus 30 according to the first startup data.

In an example, the memory controller 300 is configured to: when failing to acquire the second startup data, select the startup data storage device 700 in the test fixture based on the select signal, and supplies power to the startup data storage device 700; then send the clock signal and the startup data request signal to the startup data storage device 700, and then sample, based on the clock signal, the first startup data provided by the startup data storage device 700 in response to the startup data request signal; and finally perform the initialization operation on the memory controller 300 according to the first startup data.

In some examples, the test interface 200 may comprise a plurality of test pads, and the memory controller 300 is connected with each of the test pads;
the test connector 800 comprises a plurality of ejector pins each being connected with the startup data storage device 700 and being in contact connection with one of the test pads, so as to form a turned-on wire between the memory controller 300 and the startup data storage device 700.

A connection relationship between the plurality of test pads and the pins of the memory controller 300, as well as a connection relationship between the plurality of ejector pins and the test pads and the pins of the startup data storage device 700, may be referred to the above, which is no long repeated here.

In the test system provided by the examples of the present disclosure, the startup data storage device that provides the first startup data is disposed on the test fixture. When the memory controller in the memory apparatus fails to complete the system initialization due to a failure in acquiring the second startup data therein, the startup data storage device on the test fixture is enabled to provide the first startup data to the memory controller. In this example, the test interface is used to replace the installation locations on the memory apparatus that are reserved for the external storage devices and the related components. First, there is substantially no impact on a layout of other devices on the memory apparatus, and the test interface has a smaller footprint and a more flexible wiring, thereby simplifying a design of the main circuit board and facilitating the device miniaturization. Furthermore, when there is a problem in the initialization, neither manual soldering of the external storage device and the related components, nor burning of the first startup data to the external storage device is required, thereby greatly improving the debugging efficiency. In addition, test interfaces may be reserved at the same position for memory apparatuses of different models, so that test fixtures are fabricated uniformly. That is, several test fixtures 70 are introduced in one time, and each project can use the test fixtures, thereby reducing the test cost.

The methods disclosed in several method examples as provided by the present disclosure may be combined freely to obtain new method examples in case of no conflicts. The above descriptions are merely example implementations of the present disclosure, and the protection scope of the present disclosure is not limited to these. Any variation or replacement that may be readily figured out by those skilled in this technical field within the technical scope disclosed by the present disclosure shall fall within the protection scope of the present disclosure.

What is claimed is:

1. A memory apparatus, comprising:
a main circuit board comprising a test interface configured to receive first startup data; and
a memory controller disposed on the main circuit board and connected to the test interface, wherein the memory controller stores second startup data, and the memory controller is configured to:
acquire the second startup data;
in response to determining that acquiring the second startup data fails, acquire the first startup data through the test interface; and
perform an initialization operation on the memory apparatus according to the first startup data.

2. The memory apparatus of claim 1, wherein the memory controller is configured to:
in response to determining that acquring the second startup data fails, enable, based on a select signal, an external storage device that provides the first startup data, generate a startup data request signal, and receive the first startup data provided by the external storage device in response to the startup data request signal; and
wherein the test interface is further configured to output the select signal and the startup data request signal.

3. The memory apparatus of claim 2, wherein the memory controller is configured to:
output a clock signal through the test interface and sample the first startup data based on the clock signal; and
provide a supply voltage and a ground voltage to the external storage device through the test interface.

4. The memory apparatus of claim 3, wherein the test interface comprises a plurality of test pads; and
the memory controller is connected with the plurality of test pads, so as to output the select signal, the startup data request signal, the clock signal, the supply voltage, and the ground voltage, and receive the first startup data through the plurality of test pads.

5. The memory apparatus of claim 4, wherein the test interface comprises:
a first test pad connected to a supply pin of the memory controller and configured to output the supply voltage;
a second test pad connected to a ground pin of the memory controller and configured to output the ground voltage;
a third test pad connected to a chip select signal pin of the memory controller and configured to output the select signal;
a fourth test pad connected to a clock pin of the memory controller and configured to output the clock signal;
a fifth test pad connected to a signal output pin of the memory controller and configured to output the startup data request signal; and
a sixth test pad connected to a signal input pin of the memory controller and configured to receive the first startup data.

6. The memory apparatus of claim 1, wherein the first startup data comprises a read-only memory code and a bootloader; and
the memory controller is configured to: run a read-only memory program according to the read-only memory code, verify the bootloader using the read-only memory program, and run the bootloader according to the verified bootloader, so as to complete the initialization operation.

7. The memory apparatus of claim 1, wherein the memory controller is further configured to:
after being powered on, acquire the second startup data; and
when succeeding in acquiring the second startup data, perform the initialization operation on the memory apparatus according to the second startup data.

8. The memory apparatus of claim 1, wherein the main circuit board comprises a first side and a second side disposed oppositely, the memory controller is disposed on the first side of the main circuit board, and the test interface is disposed on the first side or the second side of the main circuit board.

9. The memory apparatus of claim 8, further comprising: an input/output connector disposed at an end of the main circuit board, wherein the test interface is located between the memory controller and the input/output connector; and
wherein the memory apparatus further comprises:
a non-volatile memory disposed on the first side of the main circuit board and located on a side of the memory controller away from the input/output connector.

10. The memory apparatus of claim 9, wherein the memory controller is configured to:
when failing to acquire the second startup data, output a startup data load failure signal through the input/output connector.

11. A test fixture, comprising:
a test substrate;
a startup data storage device disposed on the test substrate, wherein first startup data is stored in the startup data storage device; and
a test connector disposed on the test substrate and connected with the startup data storage device, wherein the test connector is configured for contact connection with a test interface on a memory apparatus.

12. The test fixture of claim 11, wherein the startup data storage device comprises: a read-only memory, wherein the first startup data is stored in the read-only memory.

13. The test fixture of claim 11, wherein the test connector comprises: a plurality of ejector pins each being configured for contact connection with one test pad in the test interface.

14. The test fixture of claim 11, further comprising:
a signal conversion module disposed on the test substrate;
a first conversion interface connected with the signal conversion module; and
a second conversion interface connected with the signal conversion module and configured to connect with an input/output connector of the memory apparatus, wherein the second conversion interface is different from the first conversion interface.

15. The test fixture of claim 14, wherein a switch is disposed between the test connector and the startup data storage device; and
after the memory apparatus outputs a startup data load failure signal, the switch is closed to enable the startup data storage device.

16. A test system, comprising:
a test fixture comprising: a startup data storage device and a test connector disposed on a test substrate, wherein first startup data is stored in the startup data storage device, and the test connector is connected with the startup data storage device; and
a memory apparatus comprising: a main circuit board and a memory controller, wherein the main circuit board comprises a test interface, the memory controller is disposed on the main circuit board and connected with the test interface, the memory apparatus is installed on the test fixture, and the test interface and the test connector are in contact connection.

17. The test system of claim 16, wherein the memory controller stores second startup data; and
the memory controller is configured to: acquire the second startup data; when failing to acquire the second startup data, acquire first startup data in the startup data storage device; and perform an initialization operation on the memory apparatus according to the first startup data.

18. The test system of claim 17, wherein the memory controller is configured to:
when failing to acquire the second startup data, enable the startup data storage device based on a select signal, send a startup data request signal to the startup data storage device, and receive the first startup data provided by the startup data storage device in response to the startup data request signal.

19. The test system of claim 18, wherein the test interface comprises a plurality of test pads, and the memory controller is connected with the plurality of test pads; and
the test connector comprises a plurality of ejector pins, the startup data storage device is connected with the plurality of ejector pins, and each of the ejector pins is in contact connection with one of the test pads.

20. The test system of claim 19, wherein the test interface comprises:
a first test pad connected to a supply pin of the memory controller and configured to supply a supply voltage to the startup data storage device;
a second test pad connected to a ground pin of the memory controller and configured to supply a ground voltage to the startup data storage device;
a third test pad connected to a chip select signal pin of the memory controller and configured to output the select signal to the startup data storage device;
a fourth test pad connected to a clock pin of the memory controller and configured to provide a clock signal to the startup data storage device;
a fifth test pad connected to a signal output pin of the memory controller and configured to output the startup data request signal to the startup data storage device; and
a sixth test pad connected to a signal input pin of the memory controller and configured to receive the first startup data from the startup data storage device.
